(19) United States
(12) Patent Application Publication
(10) Pub. No.: US 2026/0077498 A1
(43) Pub. Date: Mar. 19, 2026

(54) DIRECT DRIVE ACTUATION AND CONTROL IN A ROBOTIC PHARMACEUTICAL PREPARATION SYSTEM

(71) Applicant: EQUASHIELD MEDICAL LTD, Migdal Tefen (IL)

(72) Inventors: Eric SHEM-TOV, Ramat Hasharon (IL); Boaz SLAV, Haifa (IL)

(21) Appl. No.: 19/391,452

(22) Filed: Nov. 17, 2025

Related U.S. Application Data
(63) Continuation of application No. PCT/IL2024/050503, filed on May 22, 2024.
(60) Provisional application No. 63/468,849, filed on May 25, 2023.

(51) Int. Cl. B25J 9/16; B25J 11/00

(52) U.S. Cl. CPC B25J 9/1664; B25J 9/1651; B25J 9/1679; B25J 11/009

(57) ABSTRACT

A robotic pharmaceutical preparation system comprising at least one container-receiving module configured to hold at least one container; a motor coupled to the container-receiving module for directly driving movement of the container-receiving module along a movement path; circuitry configured to detect electrical current consumption of the at least one motor; and a controller configured for: receiving an indication from the circuitry regarding the electrical current consumption; determining that an interference exists based on the indication; and upon determining that an interference exists, modifying operation of the system.

### TECHNOLOGICAL FIELD

The present application generally relates to robotic pharmaceutical preparation systems, and more particularly to direct drive actuation of one or more container-receiving modules of the system, and control thereof.

### BACKGROUND

U.S. Pat No. 9,579,255B2 discloses “. . . an Automated Pharmacy Admixture System (APAS) may include a manipulator system to transport medical containers such as bags, vials, or syringes in a compounding chamber regulated to a pressure below atmospheric pressure. In a preferred implementation, the manipulator system is configured to grasp and convey syringes, IV bags, and vials of varying shapes and sizes from a storage system in an adjacent chamber regulated at a pressure above atmospheric pressure. Various embodiments may include a controller adapted to actuate the manipulator system to bring a fill port of an IV bag, vial, or syringe into register with a filling port at a fluid transfer station in the chamber. A preferred implementation includes a sanitization system that can substantially sanitize a bung on a fill port of a vial or IV bag in preparation for transport to the fluid transfer station.”

### GENERAL DESCRIPTION

A robotic pharmaceutical preparation system may comprise an automatic or partially automatic system comprising manipulator(s) and/or module(s) controlled at least partially by a controller. The robotic pharmaceutical preparation system can be operable for performing any activity related to preparation of drugs, such as drugs designated for administration to patients, including, for example, compounding, diluting, reconstituting, transferring, filling, drawing, agitating and/or other processes associated with pharmaceutical preparation.

The robotic pharmaceutical preparation system is configured for receiving and optionally manipulating various types of containers, such as drug vials, intravenous (IV) bags, syringes, tubes, and/or other containers suitable for holding and/or transferring fluid and/or powder. In some examples, the robotic pharmaceutical preparation system is configured for receiving at least one drug vial; diluting or reconstituting the drug in the vial, as needed; optionally, agitating the vial; and then obtaining, by drawing from the vial, a defined amount of the ready drug. In some cases, the drug is then prepared for administration to a patient, for example by transferring the drug into a syringe and/or into an IV bag.

The pharmaceutical preparation system may be deployed for preparation of any type of drug, including a hazardous drug which is prepared in closed systems, as well as non-hazardous drugs. In closed fluid transfer systems deployed for preparation of hazardous drugs, measures are taken to prevent hazardous leakage of fluid and/or fume from the containers such as a syringe, a vial, an IV bag or the like. For ensuring alignment and providing a secured coupling during fluid transfer, connectors or adaptors can be used with the containers and/or generally used at fluid transfer interfaces of the system.

Robotic pharmaceutical preparation systems as described herein can be used inside a controlled environment, optionally, a sterile environment which provides for reducing or preventing exposure to hazardous gases and/or materials. In some embodiments, the system is used inside a hood (such as a fume hood), in which ventilation is controlled. In some cases, access to the system is via an opening of the hood, e.g. an access window leading to the work surface of the hood.

In some embodiments, the robotic pharmaceutical preparation system is a collaborative machine in which there is at least some interface with a human operator (user). In some examples, the user loads and/or unloads containers to and from the system, optionally by at least partially inserting their hands into certain parts of the system and/or at certain times of the system operation cycle. Embodiments of the present disclosure aim to improve safety of the user and/or reduce risk to system components, including permanent components (e.g. modules) as well as disposable/single-use components (e.g. containers), by automatically identifying an interference (machine-derived or user-derived) and reacting to that interference.

According to an aspect of the present disclosure there is provided a robotic pharmaceutical preparation system comprising:
at least one container-receiving module configured to hold at least one container;
a motor coupled to the container-receiving module for directly driving movement of the container-receiving module along a movement path;
circuitry configured to detect electrical current consumption of the at least one motor; and
a controller configured for:
   receiving an indication from the circuitry regarding the electrical current consumption;
   determining that an interference exists based on the indication; and
   upon determining that an interference exists, modifying operation of the system.

In some embodiments, the coupling between the container-receiving module and the motor is free of transmission elements.

In some embodiments, at least a portion of the container-receiving module is coupled to the motor directly.

In some embodiments, at least a portion of the container-receiving module comprises a housing of the module or an extension thereof.

In some embodiments, the at least a portion of the container-receiving module is coupled to a moving part of the motor.

In some embodiments, the moving part of the motor constitutes a rotor or a forcer.

In some embodiments, the container-receiving module and the motor are coupled such that the container-receiving module is passively moved by the motor, and is not capable of moving on its own.

In some embodiments, the circuitry is configured as part of a driver of the motor, the driver being in communication with the controller.

In some embodiments, the data includes current consumption levels of the motor.

In some embodiments, the data further includes one or more of: speed data, position data, temperature data, vibration data.

In some embodiments, the movement path comprises a linear movement path or a curving movement path.

In some embodiments, the interference is derived from a machine source or a human source.

In some embodiments, the interference constitutes an obstacle along the movement path.

In some embodiments, the indication comprises a deviation from a preset current consumption limit or range.

In some embodiments, the controller is configured to modify operation of the motor to slow or stop the movement of the container-receiving module upon determining that an interference exists.

In some embodiments, the controller is configured to increase the force applied to the container-receiving module by the motor to overcome the interference, upon determining that an interference exists.

In some embodiments, the controller is configured to generate an alert upon determining that an interference exists.

In some embodiments, the controller is configured to control access to a hood in which the system is positioned upon determining that an interference exists.19. The system according to any one of the preceding claims, wherein the at least one container held by the container-receiving module comprises a vial, an IV bag, or a syringe.

In some embodiments, the system further comprises at least one encoder connected to one or both of the motor and the container-receiving module for detecting a position of the container-receiving module.

In some embodiments, the system further comprises at least one imager positioned and configured to acquire images of one or more of: the container-receiving module, the at least one container held by the container-receiving module; the motor; one or more areas along a movement path of the container-receiving module.

In some embodiments, the controller is configured for receiving the images acquired by the imager and for identifying at least a location of the interference based on the images.

In some embodiments, the controller is configured for receiving the images acquired by the imager and for determining if a container is currently being held by the container-receiving module.

In some embodiments, the controller determines that a container is currently being held by the container-receiving module, the controller is configured to modify operation of the motor to slow the movement of the container-receiving module.

In some embodiments, the movement path is divided into a plurality of segments which differ from each other by a preset current consumption threshold of the motor.

In some embodiments, the controller is configured to determine that an interference exists in a certain segment out of the plurality of segments if the current consumption is higher than the preset threshold for that segment.

In some embodiments, the current consumption threshold is defined based on an action or a process performed on one or both of the container-receiving module and the container within a certain segment.

In some embodiments, the action or process includes one of: loading or unloading of a container to or from the container-receiving module; transferring fluid from one container to another; agitating or inverting a container; transferring a container from one position to another; moving at least a portion of a container relative to another portion of the container.

In some embodiments, the current consumption threshold is defined based on whether manual user access to a certain segment is enabled or prohibited.

In some embodiments, the movement path is linear and each of the plurality of segments constitutes of an elongate segment of the linear path.

In some embodiments, the movement path is circular and each of the plurality of segments constitutes of a sector of the circle of the movement path.

In some embodiments, the system is shaped, sized and configured to be used inside a hood; wherein user access to the system is provided via an access window of the hood.

In some embodiments, one or more stoppers are prepositioned along the movement path for stopping movement of the module independently of the motor.

In some embodiments, the system comprises at least two container-receiving modules driven by at least two respective motors, wherein the controller is configured to synchronize operation of the at least two motors.

According to an aspect of the present disclosure there is provided a method of controlling operation of a robotic pharmaceutical preparation system, the system comprising at least one container-receiving module configured to hold at least one container, and a motor directly coupled to the container-receiving module; the method comprising:
using the motor, directly driving movement of the container-receiving module along a movement path;
detecting an electrical current consumption of the motor;
receiving at a system controller an indication regarding the electrical current consumption;
determining that an interference exists based on the indication; and
modifying operation of the system.

In some embodiments, the coupling between the container-receiving module and the motor is free of transmission elements.

In some embodiments, at least a portion of the container-receiving module is coupled to the motor directly.

In some embodiments, the at least a portion of the container-receiving module comprises a housing of the module or an extension thereof.

In some embodiments, the at least a portion of the container-receiving module is coupled to a moving part of the motor.

In some embodiments, the moving part of the motor constitutes a rotor or a forcer.

In some embodiments, the interference comprises an obstacle, obstruction or a blockage derived from a machine source or a human source.

In some embodiments, the indication comprises a deviation from a preset current consumption limit or range.

In some embodiments, modifying operation of the system comprises at least one of:
a. modifying operation of the motor to slow or stop the movement of the container-receiving module;
b. increasing the force applied to the container-receiving module by the motor to overcome the interference;
c. generating an alert.

In some embodiments, the at least one container held by the container-receiving module comprises a vial, an IV bag, or a syringe.

In some embodiments, the method further comprises dividing the movement path into a plurality of segments which differ from each other by a preset current consumption threshold of the motor.

In some embodiments, the method comprises determining that an interference exists in a certain segment out of the plurality of segments if the current consumption is higher than the preset threshold for that segment.

As referred to herein, a “container-receiving module” may include a module which receives, holds and optionally moves one or more containers, e.g. vials, IV bags, syringes and/or other containers suitable for containing and/or transferring fluid. The container-receiving module can be a permanent part of the pharmaceutical preparation system. In some embodiments, the container-receiving module is configured to move as a whole, e.g. as a single unit; additionally or alternatively, one or more portions of the module are configured to move with respect to other portion(s) of the module, for example so as to move the at least one container held at the module. In some cases, a container-receiving module is configured to be moved only when coupled to a motor, and is incapable of independently moving.

Examples of container-receiving modules can include:
a vial holder, which is configured for receiving and holding at least one vial. The vial holder can be further configured to move the vial, for example, pivot the vial to agitate the vial and/or pivot the vial to change its orientation and optionally maintain the vial at the selected orientation (e.g. an upright orientation, an inverted orientation). The vial holder can be constructed, for example, of a body and a frame which is pivotably connected to the body and is configured for grasping the vial to pivot it. In another example, a vial holder can define a surface, e.g. a platform or a tray, on which one or more vials are received. Optionally, the surface can be lifted/lowered and/or moved laterally to position the vials at a selected spatial location in the system.
an IV bag holder, which is configured for receiving and holding at least one IV bag. The IV bag holder can include designated surface(s) on which the IV bag can be mounted or laid, hangers (e.g. hooks) for holding the IV bag, and/or other elements suitable for holding and/or supporting the IV bag.
a syringe holder, which is configured for holding at least one syringe and optionally for moving the syringe. In some embodiments, the syringe holder is structured to engage portions of a syringe (or of a syringe assembly), for example, a plunger of a syringe, so as to move the engaged portion (optionally with respect to other syringe portions, e.g. so as to withdraw or inject fluid). Additionally or alternatively, the syringe holder moves the syringe as a single unit (e.g. the syringe holder travels together with the syringe back and forth along an axis).

As referred to herein, a “vial” may include a closable vessel, formed for example of glass or plastic, and containing a fluid such as a drug in liquid or powder form. The vial can be a single use vial. The vial can be tubular or bottle shaped, having a neck portion in proximity to the vial opening. The vial can be topped with a cap.

As referred to herein, a “vial assembly” may include: a vial alone, or a vial onto which a vial adaptor is mounted. A septum for at least partially sealing access to the vial can be located as part of the vial itself and/or as part of the vial adaptor. The septum may include a membrane, such as a pierceable membrane or a membrane having a closable passageway defined therethrough.

A vial adaptor can be used as part of the vial assembly referred to herein. The vial adaptor may include a device mountable onto a vial, for facilitating transfer of the vial itself (by grasping onto the adaptor instead of grasping the vial) and/or for facilitating fluid transfer into or from the vial. The vial adapter may provide closed access to the contents of the vial. The vial adaptor may be a single use, sterilized device. It is noted that the terms “vial” and “vial assembly” may be alternately used along this application.

As referred to herein, fluid typically comprises a drug, a diluent, saline solution, water or any other fluid used for pharmaceutical preparation. The terms “pharmaceutical” and “drug” may be used interchangeably.

As referred to herein, a “syringe assembly” may include a syringe alone, or a syringe with a connector attached thereto. The syringe connector may be coupled to a hub of the syringe. The syringe connector may provide closed access and may facilitate fluid transfer. A septum may be configured as part of or mounted onto the syringe connector, such that upon engagement of the syringe assembly with a vial assembly, the two septa may interface with each other. It is noted that the terms “syringe” and “syringe assembly” may be alternately used along this application. It is further noted that a syringe can be generally replaced by any suitable container from which fluid can be injected, and/or by which fluid can be drawn (e.g. an IV bag used with a pump, tubing used with a pump, and as such).

As referred to herein, a controller may comprise a component configured to perform operations in accordance with a set of instructions stored on a memory readable by the controller, which may be executed by a central processing unit (CPU), one or more processors, processor units, microprocessors, etc. The controller may include one or more control circuits. The controller may comprise any means to control elements in the robotic pharmaceutical preparation system and may comprise at least any one of a controller, a synchronizing unit and a processer.

A needle may comprise a cannula or any other device configured for penetrating a container and transferring fluid and/or gas therethrough. The needle may include a bevel at a distal tip thereof or an opening at a side surface or any other configuration.

### BRIEF DESCRIPTION OF THE DRAWINGS

In order to better understand the subject matter that is disclosed herein and to exemplify how it may be carried out in practice, examples will now be described, by way of non-limiting example only, with reference to the accompanying drawings, in which:

FIG. 1 is a schematic block diagram of a pharmaceutical preparation system in which a container-receiving module is moved by a direct drive actuator, according to embodiments of the present disclosure;

FIG. 2 is a schematic graph demonstrating how existence of an interference along a movement path of the container-receiving module is determined by monitoring electrical current consumption of the motor, according to embodiments of the presently disclosed subject matter;

FIG. 3 is a flowchart of a method of determining existence of an interference by monitoring electrical current consumption of the motor, according to embodiments of the presently disclosed subject matter;

FIG. 4 illustrates direct drive actuation along a linear movement path of a container-receiving module constituting of a syringe holder, according to embodiments of the presently disclosed subject matter;

FIG. 5 illustrates direct drive actuation along a circular movement path of a container-receiving module constituting of a vial holder (only a portion of which is shown), according to embodiments of the presently disclosed subject matter;

FIG. 6 illustrates direct drive actuation along a linear movement path of a container-receiving module constituting of a platform which holds vials, according to embodiments of the presently disclosed subject matter;

FIG. 7 illustrates direct drive actuation along a linear movement path of a part of a container-receiving module constituting of a syringe holder, according to embodiments of the presently disclosed subject matter;

FIG. 8 is a flowchart of a method for determining existence of an interference along a movement path divided into a plurality of segments, each segment having a different motor current consumption threshold, according to embodiments of the presently disclosed subject matter;

FIGS. 9A-B schematically illustrate a linear movement path (FIG. 9A) and a circular movement path (FIG. 9B) each divided into a plurality of segments having different current consumption thresholds, according to embodiments of the presently disclosed subject matter; and

FIG. 10 shows an example of a linear movement path of a syringe holder as shown in FIG. 4, divided into a plurality of segments characterized by different current consumption thresholds, according to embodiments of the presently disclosed subject matter.

### DETAILED DESCRIPTION

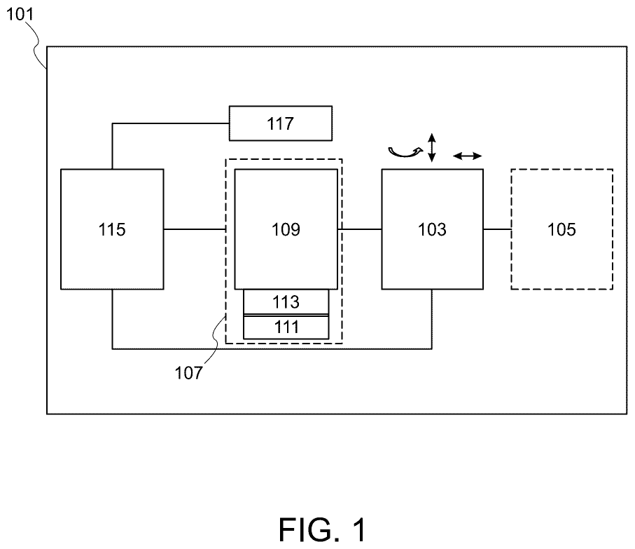

FIG. 1 is a schematic block diagram of a pharmaceutical preparation system in which a container-receiving module is moved by a direct drive actuator, according to embodiments of the present disclosure.

A system 101 of the present example includes one or more container-receiving modules 103, each module configured to receive, hold and optionally manipulate (e.g. move) at least one container 105 or a portion of the container. Examples of containers received at a container-receiving module include a vial, a syringe, an IV bag, and/or other containers suitable for containing and/or transferring fluids (liquids and/or gases), and/or powder. In some embodiments, the container is a single-use, disposable container.

The container-receiving module is connected directly to a motor drive 107, which actuates its movement. The motor drive is positioned and configured to move the module along a selected movement path, for example, a linear movement path, a circular or otherwise curving movement path, or otherwise shaped path. The motor drive is generally comprised of a motor 109, circuitry for controlling the motor's speed, direction and/or torque, power supply 111, and an encoder 113, which is configured for sensing the motor's speed, position and/or direction.

A coupling of the container-receiving module to the motor drive is direct and free of transmission elements. No intermediate components such as gears, lead screws and as such are configured between the module and the motor drive. Due to the direct coupling, the amount of force generated by the motor is equivalent to the amount of force acting on the module itself, and no amplification, reduction or other modification is carried out. The force applied to the module that is being moved is in direct correlation with the current consumption of the motor, which is being monitored.

Such direct coupling can be advantageous in that no backlash exists (since there are no gaps between these system parts, there is no clearance or lost motion), thereby potentially improving the precision. For example, a module can be moved from a first position to a second position in a precise manner, without overshoot or undershoot. Additional potential advantages of directly coupling the motor to the module may include having no intermediate transmission elements (such as a gear train). By that, the overall weight and/or volume of the assembly can be kept to a minimum; construction can be simplified; and heat dissipation from the motor can be more efficient, e.g. as compared to when intermediate transmission elements are used.

In some examples of direct coupling, a part of the container-receiving module (e.g. a part of the module housing, a gripper of the container, an extension of a gripper, or any other part of the module (and not of the container)) is directly connected to an active, moving part of the motor, for example to a rotor of the motor (in the example of rotational movement), or to a forcer of the motor (in the example of linear movement). Such direct connection can be achieved, for example, via adhesives, fixation elements (e.g. screws, bolts), a mounting, a latch and/or other suitable fasteners. In some examples, the module housing or a direct extension thereof is integral with the moving part of the motor, defining a single unit which moves together as one.

In some embodiments, the direct drive motor is continuously supplied with electrical power.

In some embodiments, one or more stoppers, e.g. physical blocking elements, are prepositioned at one or more places along the movement path of a module. The stoppers may be especially useful for ensuring that a module stops moving, for instance in a situation of power outage or shortage, in which the direct drive motor is no longer active but the module may continue its movement inertially. Use of stoppers may allow control of module movement independently of the motor.

In some embodiments, the system comprises a plurality of container-receiving modules, whereby movement of each module is driven by one or more motors which are directly connected to the module. In such arrangement, the controller of the system can be configured to synchronize operation of the motors, for example to control the timing of movement, enable an interface (e.g. a fluid interface) between containers held at the modules, preventing a collision between the modules and/or between the containers being held at the modules, and as such. Synchronization of motor operation of multiple modules (each module being directly driven by its motor) can allow placing a container at a selected position at a selected timing.

Referring back to system 101, the motor drive is in communication with a system controller 115. The controller is configured to receive input from the motor drive such as position data (e.g. rotation angle, linear displacement) and/or speed data sensed by the encoder, and electrical current consumption levels of the motor, and to control operation of the system accordingly. In some embodiments, the controller can be configured to receive additional input such as the motor temperature, the extent of motor vibration, irradiation levels from the motor and/or others, and to control operation of the system based on that input.

Due to the direct coupling of the container-receiving module to the motor drive, the electrical current consumed by the motor is expected to be correlated directly to the force (e.g. torque) applied to the module by the motor. Since the coupling is free of transmission elements, the current consumption signal is expected have no (or very low) noise. Based on the current consumption signal (or an analysis or calculation based thereon, for example, an average current consumption over time, a peak current, a change in current consumption and/or a change in current related measures such as an average), the system controller can be configured to determine that an interference exists, for example an interference occurring along the movement path of the container-receiving module, as will be further described herein.

As referred to herein, an “interference” may include: a blockage, an obstruction (full or partial), a mechanical or physical obstacle, an unexpected change in conditions, and/or any unexpected event which could interfere with or even prevent normal system operation. An interference may be caused by an internal (machine) source, e.g. due to a machine malfunction, misplacement of a container by the machine, erroneous movement of a module, breakage, mechanical wear, corrosion, misalignment of containers relative to each other (which may prevent or interfere with fluid transfer between the containers). Alternatively, an interference may be caused by an outside source, optionally, a human source, for example by a user operating the machine incorrectly, misplacing containers during loading or unloading, accidently inserting their hands into the system during operation, and the like.

An interference may be associated with one or more of: the module itself (e.g. breakage of a part of the module); the module's movement path (e.g. an object existing along the path); the one or more containers received at the module and/or their contents (e.g. a misoriented container).

In some embodiments, system 101 comprises one or more imagers 117 configured for acquiring images of the container-receiving modules and/or the containers themselves and/or of areas between the modules and/or of areas along a movement pathway of a module and/or of other parts of the system. Controller 115 is configured to receive the image data acquired by the imagers and based on that data, optionally in combination with the current consumption data and the motor position and/or speed data, to determine existence of an interference. In some cases, based on the image data, a specific location of the interference along the movement path can be assessed.

In some embodiments, an interference is first identified by analysis of image data. Additionally or alternatively, an interference is first identified according to the change in current consumption of the motor, and optionally then further characterized using image data (for example, for determining a specific location of the interference, the type or size of interference, etc).

It is noted that the motor itself can be of any suitable type, for example, an AC motor or a DC motor, a brushed or brushless motor, a stepper motor, a piezoelectric motor, and/or other suitable motor. In a specific example, the motor is an ironless brushless linear motor or rotary motor.

In some embodiments, an encoder can be positioned on or otherwise connected to the container-receiving module, in addition or alternatively to the encoder of the motor drive. Since the motor drive and the module move together as a single unit, an encoder of the module can also be used to provide position and/or speed and/or direction related data which applies to both the module and the motor altogether.

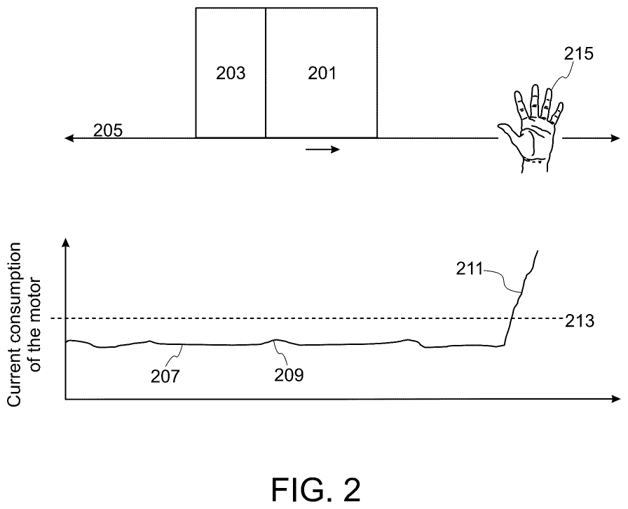

FIG. 2 is a schematic graph demonstrating how existence of an interference along a movement path of the container-receiving module is determined by monitoring electrical current consumption of the motor, according to embodiments of the presently disclosed subject matter.

In the example illustrated, a container-receiving module 201 is directly coupled to a motor drive 203 which is configured to drive movement of the module along a linear path 205 (for example, back and forth along the path). During operation, the electrical current consumption of the motor is monitored and tracked by a system controller (not shown). Line 207 demonstrates the changes in current consumption over time and in correlation with the relative position of the module (and attached motor drive) along the linear movement path. As can be seen, small fluctuations (such as 209) can normally occur during the movement; however, when a large deviation (such as 211) occurs, in which the current consumption level exceeds a predefined threshold 213, the significant rise in current consumption may be indicative of existence of an interference 215 along the movement path (for example, a user inserts their hand into the system during operation). Due to the direct drive mechanism, the current consumption curve of the motor is expected to be generally smooth (with low or no noise), therefore a significant deviation may be indicative of an interference. When the module contacts an interreference, the force applied by the motor is expected to increase (in attempt to continue movement of the module at a preset speed), causing the rise in current consumption.

Threshold 213 may be defined taking various parameters into account, for example: the type of movement carried out by the container-receiving module; the kind of motor being used; physical dimensions of the container-receiving module, optionally with the container(s) held by the module (total weight, size); the level of sensitivity to interferences that is needed (for example, the threshold can be set as high enough so that a dust particle will not be identified as an interference, yet low enough so that a user's finger, a misplaced container or as such will be identified as an interference).

In some cases, the threshold is defined to be high enough so that fluctuations caused for example by movement of cables connected to the motor, periodic movement of the motor, vibrations (e.g. vibrations caused by adjacent machinery) or the like will not be identified as an interference; while inserted hands of a user, misplaced and/or fallen containers, additional parts of the system which are dispositioned and as such will be identified as an interference.

In some embodiments, a range for the current consumption is defined, with lower and upper limits. If the current consumption rises and exceeds the upper limit, this may be indicative of an interference, which causes an overload on the motor; and if the current consumption is lower than the lower limit it may be indicative of an unexpected lower load, mechanical damage, electrical issues and/or power supply issues. A drop in current may also occur right after an interference has been overcome by the module, and/or if the supplied power was set to be sufficient for a certain action to take place, e.g. connecting a syringe to a vial, but the action could not have occurred, for example due to a missing or a misaligned container.

In some cases, due to the use of a direct drive mechanism, an interference can be detected immediately, such as with within 10-50, 10-100, 30-200 msec or intermediate, higher or lower time periods of the module contacting the interference. In some embodiments, the time period from encountering the interference to detecting its existence by the system controller is a function of the communication between the motor drive circuitry and the controller, for example, the rate in which the motor drive signals to the controller. Immediate detection can be advantageous for ensuring safety of both the system and the user operating the system. In an example, if a user inserts their hand(s) into the hood into an area which is not supposed to be in reach (and/or at a timing other than loading/unloading of containers, when manual access may be permitted), immediately detecting the hand(s) as an interference may reduce or prevent a risk of physical damage to the user and/or to system components, exposure of the user to hazardous materials, spills, contamination, and the like.

It is noted that in some cases, an interference may be detected before the container-receiving module actually comes in contact with it. This can be achieved for example with the use of imagers which are directed at the movement path of the module. In such case, the module can be stopped or slowed before it actually reaches the interference. In an example, if a user inserts their hand into the hood, presence of the hand and optionally a specific location of the hand may be first identified by one or more imagers. Based on the captured images, the system controller may modify operation of one or more modules, such as modules with a movement path which coincides with the location of the hand. For example, a platform of the system which is raised and lowered can be slowed or fully stopped when presence of a hand is detected.

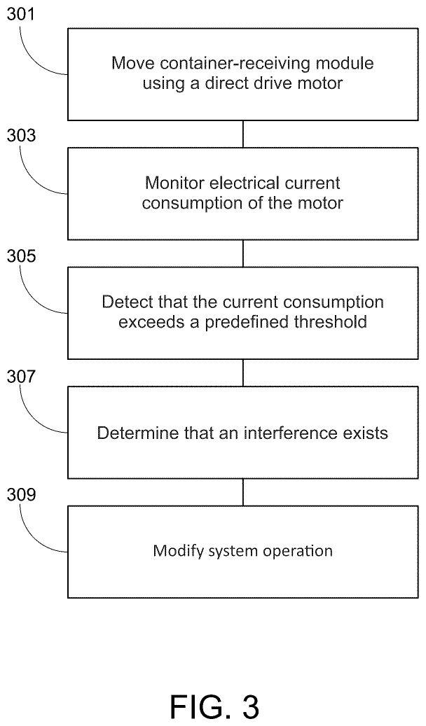

FIG. 3 is a flowchart of a method of determining existence of an interference by monitoring electrical current consumption of the motor, according to embodiments of the presently disclosed subject matter.

At 301, as previously described, a container-receiving module is moved along a defined movement path by a direct drive motor. At 303, during operation of the motor, electrical current consumption of the motor is monitored. In some embodiments, the current consumption of the motor is sensed via suitable circuitry of the motor drive (such as via resistor(s), transformer(s) and/or other suitable sensing components). In some examples, the motor drive circuitry is configured to sample the current consumption of the motor at a rate which is high enough to effectively provide continuous monitoring of the current consumed by the motor.

At 305, if and when the measured current consumption exceeds a predefined threshold, a determination can be made by the system controller that an interference exists (see 307).

In such situation, in which it is determined that an interference exists along the movement path of the module, the system controller can decide to modify operation of the system (see 309), for example by one or more of:
issuing an error or a warning notification via a user interface (e.g. a screen) of the system, using for example audible and/or visible notifications;
modifying operation of the motor to slow the movement of the module;
modifying operation of the motor to stop the movement of the module, immediately or gradually. Stopping the movement may be advantageous for preventing overheating and potential failure of the motor, as well as for maintaining safe operating conditions for both the user and the system itself.
modifying operation of the motor to accelerate the movement of the module and/or raise the force (e.g. torque) level applied by the motor to the module so as to try and overcome the interference;
shutting off the power supply to the motor and optionally to other system motor(s);
fully shutting down the system;
   controlling access to a hood in which the system is positioned, for example, locking an access window of the hood if an interference was detected to prevent a user from accessing the system, or instead, opening the access window to enable manual removal of the interference. In some cases, the system maintains the access window at a normally closed state, and enables it to open only at certain times of operation and/or if certain safety conditions are met (e.g. if no containers have fallen or broken). It is noted that an interference may be of a kind that fully blocks the movement path, or only partially blocks the path. An interference may be stationary (e.g. a container that was misplaced or had fallen) or moving (e.g. a hand of a user, another module of the system). An interference may be one that affects operation only locally, i.e. affecting operation only of the module that encounters it, or instead an interference that widely affects the system operation, for example an interference that is in the way of additional system module(s). An interference may be caused by misalignment of components, for example, if a syringe is misaligned (e.g. is not in a direct opposite position) with respect to a vial or an IV bag, or vice versa, and their engagement cannot take place or is otherwise not suitable for fluid transfer.

In some embodiments, based on the extent of the change (e.g. rise or drop) in current consumption, the rate (slope) of the change, the timing of the change, and/or other measures of the tracked current consumption, the controller is configured to determine whether the interference can potentially be overcome by continuing the motion of the module (e.g. by increasing the force applied to the module by the motor, increasing the speed of the motor, and as such) or, if the interference is of a type, size and/or at a position in which it is preferred or required that the module would stop moving.

In some embodiments, the controller is configured to assess certain properties of the interference based on the measures of current consumption. For example, a sharp sudden rise in current consumption may indicate that the module had bumped into a rigid (solid) interference which optionally cannot be pushed further or deformed by the module, such as a another system component (e.g. module), a vial, a syringe;. A gradual rise having a smaller slope and/or a lower peak may indicate that the module encountered a softer interference, which can optionally be pushed or deformed in response to force applied onto it by the module, such as a user's hand, an IV bag, cables of the system, or as such.

Optionally, properties of the interference (such as size, weight, position, orientation) are assessed with the aid of additional input such as data acquired by the imagers and/or other data pertaining to the motor, such as position data provided by the encoder, temperature data, vibration data, and the like.

In some cases, the controller is configured to decide on the preferred manner of modifying system operation by checking if a container is currently being held by the module or not. For example, if one or more containers are currently held by the module, it may be preferred to slow or stop the module upon identifying an interference; while if the module is empty and is not carrying any containers, it may be preferred to accelerate its motion so as to try and override the interference. In some embodiments, an indication of whether or not a container is currently being held at the module is reached by analyzing images acquired by the one or imagers of the system.

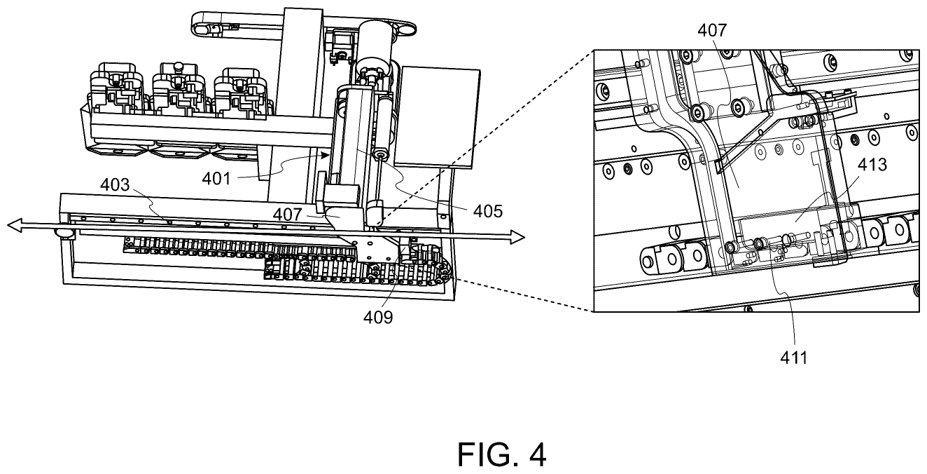

The following FIGS. 4-7 show examples of container-receiving modules of the pharmaceutical preparation system, each directly actuated by a motor. Each of the modules is configured to be moved along a movement path (such as a linear path or a curving path). Identifying of an interference along the module movement path and handling thereof may be performed for example as described hereinabove.

FIG. 4 illustrates direct drive actuation along a linear movement path of a container-receiving module constituting of a syringe holder, according to embodiments of the presently disclosed subject matter.

In the example shown, a syringe holder 401 is configured to slide along a rail 403, configured at a bottom portion of an infrastructure of the system. A housing 405 of the syringe holder extends upwardly from a platform 407 which directly connects the housing to a motor 409 that drives movement of the syringe holder back and forth along the rail. As can be seen in the enlarged view, in the example shown, platform 407 is connected via a plurality of fixation elements, e.g. screws 411, to a forcer 413 of the motor.

Some examples of interferences which may be detected by monitoring current consumption of the direct drive motor of the syringe holder include: objects (e.g. containers) that are erroneously along the movement path, inserted hands of a user, collision with other modules of the system (e.g. with a vertically moving platform), a syringe that is held at a non-expected (e.g. non-vertical) orientation with respect to the holder.

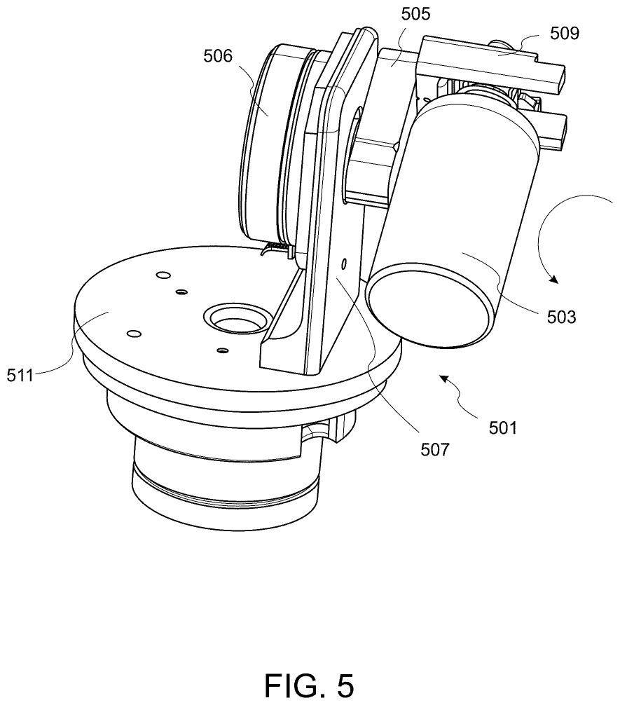

FIG. 5 illustrates direct drive actuation along a circular movement path of a container-receiving module constituting of a vial holder (only a portion of which is shown), according to embodiments of the presently disclosed subject matter.

In the example shown, a vial holder 501 is configured to agitate and/or invert a vial 503 by pivotal movement. The vial holder comprises a pivot plate 505 which is connected directly to a rotor (not shown) of a motor 506 (an external housing of the motor is shown). Turning of the rotor pivots the plate relative to a body 507 of the vial holder, thereby rotating a frame 509 which extends from the plate and grasps the vial.

Some examples of interferences which may be detected by monitoring current consumption of the direct drive motor of the vial holder include: inserted hands of a user, collision with other modules of the system, collision with other containers of the system, e.g. a syringe that is supposed to be aligned with a vial held by the vial holder to enable their interface, but is unexpectedly disoriented.

In some embodiments, body 507 of the vial holder is mounted on a rotating platform 511, which upon rotation changes a position of the vial holder with the vial being held by it. Commonly, at least one additional vial holder is positioned on the rotating platform in an oppositely facing direction, such that the rotation of the platform interchanges the positions of the vial holders. In some embodiments, rotation of the platform is also driven by a direct drive motor (not shown; configured, for example, underneath the platform). In such arrangement, in which both the pivot plate of the vial holder and the rotating platform are driven by respective direct drive motors, operation of the motors can be synchronized (e.g. by the system controller) to accurately bring a vial held by the vial holder to a specific position (both a rotational position and an angular/pivotal position (e.g. ranging between an inverted and an upright state).

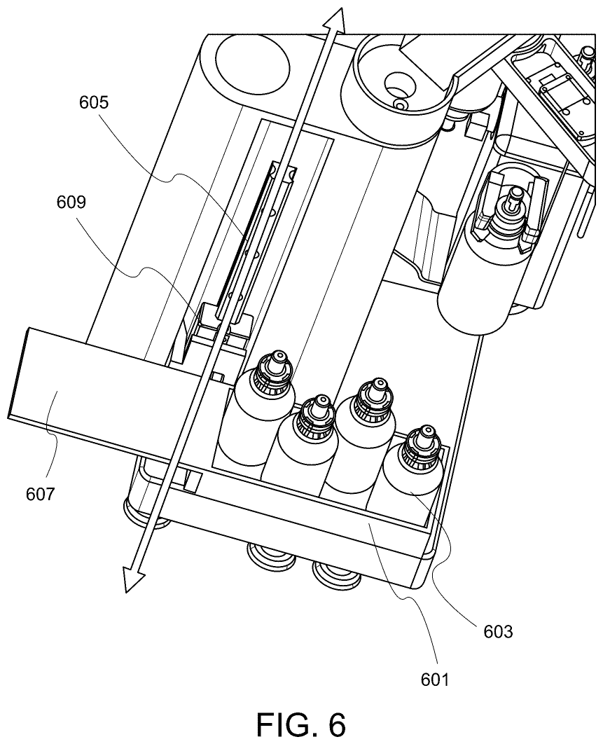

FIG. 6 illustrates direct drive actuation along a linear movement path of a container-receiving module constituting of a platform which holds vials, according to embodiments of the presently disclosed subject matter.

In the example shown, a platform 601 which holds a plurality of vials 603 is configured to move linearly along a vertically extending rail 605, thereby raising or lowering the vials. The platform comprises a side extension 607 which is connected directly to a motor 609 which travels up and down along the rail.

Some examples of interferences which may be detected by monitoring current consumption of the direct drive motor which actuates vertical movement of the platform include: inserted hands of a user, collision with other modules of the system, and/or if a vial of unexpected size, e.g. height, is placed on the platform, and may bump into the system infrastructure during movement of the platform.

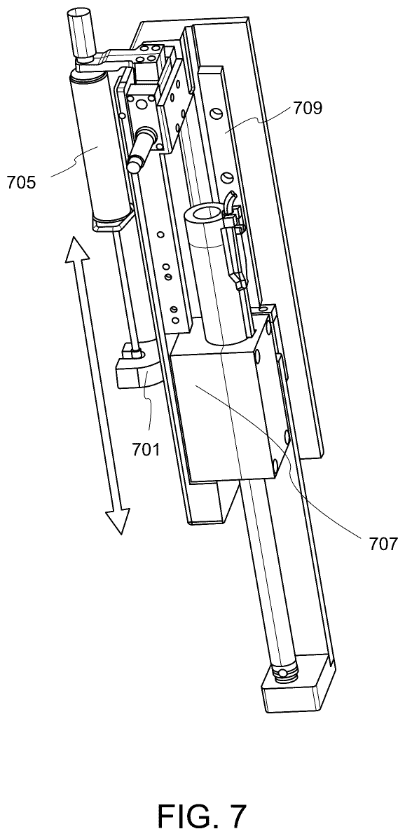

FIG. 7 illustrates direct drive actuation along a linear movement path of a part of a container-receiving module constituting of a syringe holder, according to embodiments of the presently disclosed subject matter.

In the example shown, portion 701 of a syringe holder 703 is configured to receive and fittingly hold a plunger flange of a syringe 705. Portion 701 (also referred to herein as “plunger receiver”) is directly connected to a motor 707 which moves the portion linearly along at least a portion of a vertical rail 709. When plunger receiver 701 is moved downwards, the syringe plunger is pulled for drawing fluid into the syringe; when plunger receiver 701 is moved upwards, the syringe plunger is pushed for injecting fluid from the syringe.

Some examples of interferences which may be detected by monitoring current consumption of the direct drive motor which actuates movement of the plunger receiver include: inserted hands of a user, collision with other modules of the system, lack of an interfacing container (e.g. a vial) and/or disorientation thereof which may prevent fluid from being drawn or injected from the otherwise sealed syringe (in such case, the plunger receiver would try to push or pull the plunger but would eventually be stopped due to pressure build-up inside the syringe). Additional examples of interferences which may be detected by monitoring current consumption of the motor which actuates the plunger receiver may include an unexpected viscosity of the fluid (e.g. too high or too low), existence of granulate or particles which may affect the force required for pulling or pushing the plunger, or others.

In some embodiments, the consumption of electrical current by the motor is not homogenous, and is expected to vary, for example vary as the module is moved along the movement path. Therefore, in some embodiments, a movement path of a module can be divided into a plurality of areas or segments which differ from each other by an expected current consumption limit or range. A deviation from a specified limit or range which occurs while the motor (and module) are within a certain segment may be indicative of an interference found within that segment.

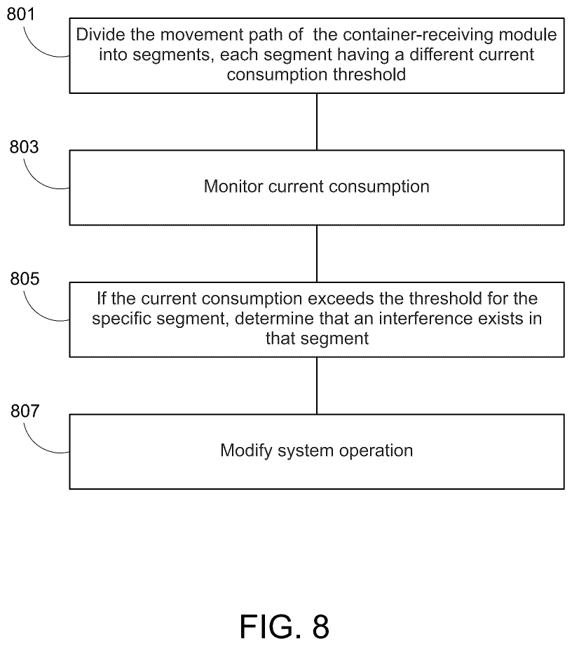

FIG. 8 is a flowchart of a method for determining existence of an interference along a movement path divided into a plurality of segments, each segment having a different current consumption threshold, according to embodiments of the presently disclosed subject matter.

At 801, a movement path of a container-receiving module is divided into a plurality of segments (e.g. 2, 3, 4, 5, 6, 8, 10 segments), each having a different current consumption threshold. The segments are inputted into the system so that position data received from the motor drive encoder (and/or from an encoder configured on the module itself, and/or from the system imagers) enables the system controller to determine in which segment the module is currently located, and therefore, which threshold should be applied.

In some embodiments, the threshold is set while taking into account the magnitude of force that is required to be generated by the motor for actuating the module in a specific segment. The amount of required force may be a function of an action or a process occurring within that segment. For example, sliding the module along a rail may require force of a lower magnitude than the force required for maintaining a module stationary and stable while a container is being loaded or unloaded from the module; pivoting a part of the module may require force of a higher magnitude than simply holding that part stationary; and as such. Additionally or alternatively, the threshold of a segment can be set taking into account safety requirements. For example, in segments which are manually accessible by a user (e.g. for inserting or removing containers), the threshold may be lower than in segments which are not user accessible. This may be advantageous in that an interference caused by the user (such as at a timing in which the user is not supposed to access the system) may be detected more easily and/or quickly, and further, the user would be at less risk since the maximal force applied by the motor would be limited to a lower magnitude.

At 803, during movement of the module, the current consumption of the motor is monitored, for example as described herein. At 805, if the current consumption exceeds the threshold for the segment in which the module is currently located, the controller may determine that an interference exists in that segment.

At 807, if an interference was identified, the controller can modify the system operation for example in any of the manners described hereinabove.

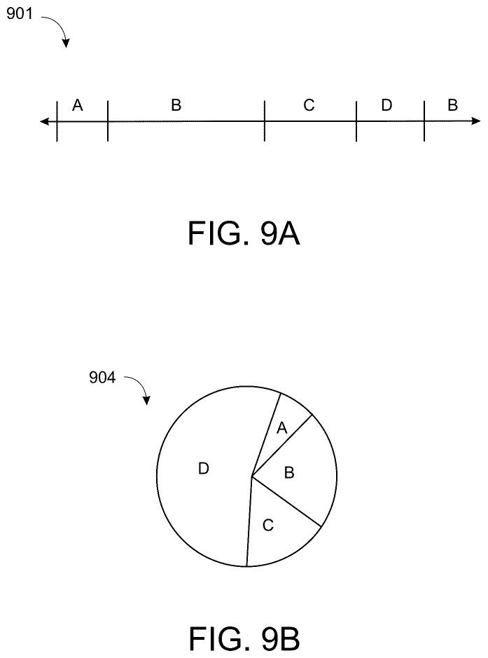

FIGS. 9A-B schematically illustrate a linear movement path (FIG. 9A) and a circular movement path (FIG. 9B) each divided into a plurality of segments having different current consumption thresholds, according to embodiments of the presently disclosed subject matter.

In FIG. 9A, a linear movement path 901 of a container-receiving module is schematically divided into multiple segments (in this example, 5 segments). A current threshold in the first segment is denoted “A”, in the second segment “B”, and so forth. Each of the segments in this example is defined along a selected distance of the movement path. In an example, a path of a container-receiving module which slides along a linear rail may be divided according to the arrangement shown in FIG. 9A.

In FIG. 9B, a circular movement path 904 of a container-receiving module is schematically divided into sectors (in this example, 4 sectors). Each of the sectors can be defined by the length of its arc, along which the module (or a part of the module) travels. In an example, a path of a container-receiving module which includes a part that pivots to rotate or invert a container may be divided according to the arrangement shown in FIG. 9B.

It is noted that a movement path of a container-receiving module (and/or a moving portion thereof) is not limited to a linear path or a circular path and can be formed along a path of any form or curvature. Commonly, a container-receiving module is moved back and forth along the path.

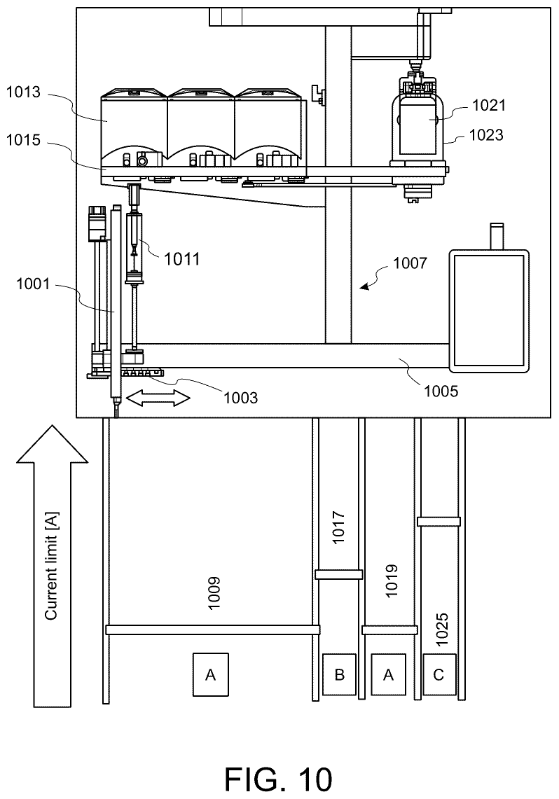

FIG. 10 shows an example of a linear movement path of a syringe holder as shown in FIG. 4, divided into a plurality of segments, according to embodiments of the presently disclosed subject matter.

In this example, syringe holder 1001 is configured to be moved by its direct drive motor 1003 along a horizontal movement path which extends along a bottom portion 1005 of the system infrastructure 1007.

The movement path is divided into four segments, where for each segment a different current consumption threshold is set. For selecting the threshold, the type of process and/or action expected to take place in that segment is taken into consideration.

In segment 1009, the syringe holder is advanced or retracted along its path in order to position a syringe 1011 held by the holder under other containers and/or modules, for example, under an IV bag 1013 situated on a platform 1015. The force that needs to be generated by the motor in that segment needs to high enough to produce acceleration (and deceleration) of the syringe holder. A threshold for the current consumption along that segment is set to “A”.

In segment 1017, the syringe holder needs to be held steady while a user accessing the system manually loads or unloads a syringe to or from the syringe holder. The force that needs to be generated by the motor in that segment needs to high enough to withstand counteracting forces acting on the module during loading or unloading of the syringe. (It is noted that in other embodiments, the syringe holder can be configured to automatically grasp or receive a syringe, for example from a syringe conveyor). A threshold for the current consumption along that segment is set to “B”.

In segment 1019, similar to segment 1009, the syringe holder is advanced or retracted along its path in order to position syringe 1011 held by the holder under other containers and/or modules, for example, under a vial 1021 which is held by a vial holder 1023. The force that needs to be generated by the motor in that segment needs to high enough to produce acceleration (and deceleration) of the syringe holder. A threshold for the current consumption along that segment is again set to “A”.

In segment 1025, the syringe holder needs to be held steady while the syringe is pulled away from the holder or returned back to the holder, for example, when the syringe connects to vial 1021 (when the vial is inverted). The force that needs to be generated by the motor in that segment needs to be high enough to withstand the pull/push forces acting on it when the syringe is pulled away from the holder or returned to the holder. A threshold for the current consumption along that segment is set to “C”.

While various inventive examples have been described and illustrated herein, those of ordinary skill in the art will readily envision a variety of other means, materials, or structure for performing the function, obtaining the results, or one or more of the advantages described herein, and each of such variations or modifications is deemed to be within the scope of the inventive examples described herein. More generally, those skilled in the art will readily appreciate that all parameters, dimensions, materials, and configurations described herein are meant to be for example only and that the actual parameters, dimensions, materials, and configurations will depend upon the specific application or applications for which the inventive teachings is/are used. Those skilled in the art will recognize or be able to ascertain using no more than routine experimentation, many equivalents to the specific inventive examples described herein. It is, therefore, to be understood that the foregoing examples are presented by way of example only and that, within the scope of the appended claims, equivalents thereto, and any claims supported by the present disclosure, inventive examples may be practiced otherwise than as specifically described and claimed. Inventive examples of the present disclosure are directed to each individual feature, system, article, material, composition, kit, method, and step, described herein. In addition, any combination of two or more such features, systems, articles, materials, compositions, kits, methods, and steps, if such features, systems, articles, materials, compositions, kits, methods, and steps, are not mutually inconsistent, is included within the inventive scope of the present disclosure.

Examples disclosed herein may also be combined with one or more features, functionality, or materials, as well as complete systems, devices or methods, to yield yet other examples and inventions. Moreover, some examples, may be distinguishable from the prior art by specifically lacking one and/or another feature disclosed in the particular prior art reference(s); i.e., claims to some examples may be distinguishable from the prior art by including one or more negative limitations.

Also, as noted, various inventive concepts may be embodied as one or more methods, of which an example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one example, to A only (optionally including elements other than B); in another example, to B only (optionally including elements other than A); in yet another example, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one example, to at least one, optionally including more than one, A, with no B present (and optionally including elements other than B); in another example, to at least one, optionally including more than one, B, with no A present (and optionally including elements other than A); in yet another example, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Although various example embodiments have been described in detail herein, however, in view of the present disclosure many modifications are possible in the example embodiments without materially departing from the concepts of present disclosure. Accordingly, any such modifications are intended to be included in the scope of this disclosure. Likewise, while the disclosure herein contains many specific combinations, these specific combinations should not be construed as limiting the scope of the disclosure or of any of the appended claims, but are provided as a description pertinent to one or more specific embodiments that may fall within the scope of the disclosure and the appended claims. Any described features from the various embodiments disclosed may be employed in combination with other disclosed embodiments. In addition, other embodiments of the present disclosure may also be devised which lie within the scopes of the disclosure and the appended claims.

This disclosure provides various examples, embodiments, and features which, unless expressly stated or which would be mutually exclusive, should be understood to be combinable with other examples, embodiments, or features described herein.

1. A robotic pharmaceutical preparation system comprising:
at least one container-receiving module configured to hold at least one container at least during the pharmaceutical preparation;
a motor coupled to the container-receiving module for directly driving movement of the container-receiving module along a movement path;
circuitry configured to detect electrical current consumption of the at least one motor; and
a controller configured for:
receiving an indication from the circuitry regarding the electrical current consumption;
determining that an interference with movement of the at least one container-receiving module exists based on the indication; and
upon determining that an interference exists, modifying operation of the system.

2. The system according to claim 1, wherein the coupling between the container-receiving module and the motor is free of transmission elements.

3. The system according to claim 1, wherein at least a portion of the container-receiving module is coupled to the motor directly,
wherein the at least a portion of the container-receiving module comprises a housing of the module or an extension thereof.

4. The system according to claim 3, wherein the at least a portion of the container-receiving module is coupled to a moving part of the motor.

5. The system according to claim 4, wherein the moving part of the motor constitutes a rotor or a forcer.

6. The system according to claim 1, wherein the container-receiving module and the motor are coupled such that the container-receiving module is passively moved by the motor, and is not capable of moving on its own.

7. The system according to claim 1, wherein the circuitry is configured as part of a driver of the motor, the driver being in communication with the controller.

8. The system according to claim 1, wherein the movement path comprises a linear movement path or a curving movement path.

9. The system according to claim 1, wherein the interference is derived from a machine source or a human source, and constitutes an obstacle along the movement path.

10. The system according to claim 1, wherein the indication comprises a deviation from a preset current consumption limit or range.

11. The system according to claim 1, wherein the controller is configured to modify operation of the motor to slow or stop the movement of the container-receiving module upon determining that an interference exists.

12. The system according to claim 1, wherein the controller is configured to increase the force applied to the container-receiving module by the motor to overcome the interference, upon determining that an interference exists.

13. The system according to claim 1, wherein the controller is configured to generate an alert upon determining that an interference exists.

14. The system according to claim 1, wherein the controller is configured to control access to a hood in which the system is positioned upon determining that an interference exists.

15. The system according to claim 1, wherein the at least one container held by the container-receiving module comprises a vial, an IV bag, or a syringe.

16. The system according to claim 1, further comprising at least one encoder connected to one or both of the motor and the container-receiving module for detecting a position of the container-receiving module.

17. The system according to claim 1, further comprising at least one imager positioned and configured to acquire images of one or more of: the container-receiving module, the at least one container held by the container-receiving module; the motor; one or more areas along a movement path of the container-receiving module; wherein the controller is configured for receiving the images acquired by the imager and for identifying at least a location of the interference based on the images.

18. The system according to claim 17, wherein the controller is configured for receiving the images acquired by the imager and for determining if a container is currently being held by the container-receiving module; and if the controller determines that a container is currently being held by the container-receiving module, the controller is configured to modify operation of the motor to slow the movement of the container-receiving module.

19. The system according to claim 1, wherein the movement path is divided into a plurality of segments which differ from each other by a preset current consumption threshold of the motor.

20. The system according to claim 19, wherein the controller is configured to determine that an interference exists in a certain segment out of the plurality of segments if the current consumption is higher than the preset threshold for that segment.

21. The system according to claim 19, wherein the current consumption threshold is defined based on an action or a process performed on one or both of the container-receiving module and the container within a certain segment; wherein the action or process includes one of: loading or unloading of a container to or from the container-receiving module; transferring fluid from one container to another; agitating or inverting a container; transferring a container from one position to another; moving at least a portion of a container relative to another portion of the container.

22. The system according to claim 20, wherein the current consumption threshold is defined based on whether manual user access to a certain segment is enabled or prohibited.

23. The system according to claim 1, wherein the system is shaped, sized and configured to be used inside a hood; wherein user access to the system is provided via an access window of the hood.

24. The system according to claim 1, wherein one or more stoppers are prepositioned along the movement path for stopping movement of the module independently of the motor.

25. The system according to claim 1, comprising at least two container-receiving modules driven by at least two respective motors, wherein the controller is configured to synchronize operation of the at least two motors.

26. A method of controlling operation of a robotic pharmaceutical preparation system, the system comprising at least one container-receiving module configured to hold at least one container at least during the pharmaceutical preparation, and a motor directly coupled to the container-receiving module, the method comprising:
using the motor, directly driving movement of the container-receiving module along a movement path;
detecting an electrical current consumption of the motor;
receiving at a system controller an indication regarding the electrical current consumption;
determining that an interference with movement of the at least one container-receiving module exists based on the indication; and
modifying operation of the system.

27. The method according to claim 26, wherein the coupling between the container-receiving module and the motor is free of transmission elements.

28. The method according to claim 26, wherein at least a portion of the container-receiving module is coupled to the motor directly;
wherein the at least a portion of the container-receiving module comprises a housing of the module or an extension thereof.

29. The method according to claim 26, wherein modifying operation of the system comprises at least one of:
a. modifying operation of the motor to slow or stop the movement of the container-receiving module;
b. increasing the force applied to the container-receiving module by the motor to overcome the interference;
c. generating an alert.

30. The method according to claim 26, further comprising dividing the movement path into a plurality of segments which differ from each other by a preset current consumption threshold of the motor; and determining that an interference exists in a certain segment out of the plurality of segments if the current consumption is higher than the preset threshold for that segment.
